(19) United States
(12) Patent Application Publication
(10) Pub. No.: US 2026/0274562 A1
(43) Pub. Date: Sep. 17, 2026

(54) Single Lid Trash Container with Lid Inward and Downward Flipping Mechanism

(71) Applicant: Nine Stars Group (U.S.A.) Inc., Ontario, CA (US)

(72) Inventors: Shi Ping Wang, Ontario, CA (US); Jiangqun Chen, Fuzhou (CN); Youxi Luo, Fuzhou (CN)

(73) Assignee: Nine Stars Group (U.S.A.) Inc., Ontario, CA (US)

(21) Appl. No.: 19/077,243

(22) Filed: Mar. 12, 2025

(51) Int. Cl. B65F 1/16

(52) U.S. Cl. CPC B65F 1/1607; B65F 1/1638; B65F 1/1646

(57) ABSTRACT

Single Lid Trash Container with Lid Inward and Downward Flipping Arrangement A trash container is equipped with a lid inward and downward flipping arrangement which is configured to drive the lid to rotate about a flipping axis of a lid to selectively flip up the lid to an open state that the lid is positioned in an upright manner with only an upper portion of the lid extending above the container cover upwardly and a lower portion extending within the inlet opening of the container cover, and flip down the lid to a close state that the lid is positioned flatly to cover the inlet opening.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records but otherwise reserves all copyright rights whatsoever.

### BACKGROUND OF THE PRESENT INVENTION

### Field of Invention

The present invention relates to a trash container, and more particularly to a single lid trash container with a lid inward and downward flipping arrangement configured to selectively open and close the lid while maximizing the inlet opening when the lid is opened and ensuring the concealing ability when the lid is closed.

### Description of Related Arts

Trash containers are widely used in various scenarios and have become an indispensable necessity in human life. With the improvement of living standards, the trash containers with lids are produced, and the scope of use of the trash containers with lids is gradually expanding. When a user throws the trash into a trash container, he or she usually stands in front of the trash container. However, the rear end of the lid of the conventional trash container generally on the market is hinged to the top end of the rear wall of the trash container, so that the lid can be selectively opened and closed by rotating about a hinge axis.

Since each of the trash containers has a predetermined height and its cover completely extends upright above the top surface of the trash container in an open state, the overall height of the trash container becomes relatively too high when the cover is selectively opened. In addition, the top end of the lid is prone to hit the user's hand or the trash in the user's hand due to the relatively large swing radius thereof when selectively opened and closed. Especially, in some space-constrained environments, such as placing a trash container inside a cabinet or under a table, the limited space above the trash container does not allow the container lid to extend upward when it is opened, that is the upwardly extending lid occupies a considerable amount of overhead space that results in inefficient use of the space above the trash container.

For example, as shown in FIG. 13A and FIG. 13B, a conventional trash container is illustrated, which includes an upper bin body P1 and a single container lid P12 hinged on a top end of the upper bin body P1, wherein the container cover P12 completely extends vertically upward from the top end of the upper bin body P1 when the container cover P12 is selectively opened. In other words, when the lid is selectively opened, the overall height of the trash container increases for an additional heigh of the entire upwardly extended container lid P12.

Referring to FIGS. 14A to 14B of the drawings, the Chinese patent application, publication number CN221643387U, discloses a trash container with asymmetrical dual-opening covers, which includes an upper bin body P1 and a lower bin body P2 arranged to allow the upper bin body P1 to locate on the top end thereof. The upper bin body P1 is provided with a set of container covers P12 for selectively opening and closing, wherein the set of the container covers P12 includes a first cover P121 and a second cover P122 having a width greater than that of the first cover P121, wherein the first cover P121 is hingedly connected to one of the bin walls of the upper bin body P1, and the second cover P122 is hingedly connected to the other bin wall, opposing the first cover P121. The first and second covers P121, P122 are synchronously operated when selectively being opened or closed. The overall height of the trash container is relatively reduced when the first and second covers P121, P122 are selectively opened and extended upwards. However, both the first and second covers P121, P122 are still completed flipped up and extended from the top surface of the bin body P1 and one of the first and second covers P121, P122 is opened toward the user when opened for trash disposal, that gives a visual impression that the adjacent top end of the first cover P121 or the second cover P122 is likely to hit the user's hand or the trash in the user's hand, resulting in a sense of oppression and a lack of safety in the user experience. Furthermore, trash is likely to be stuck to the upper surfaces of the front sides of the first and second covers P121, P122 during discarding trash. It makes the users feel dirty and uncomfortable, and the structure of the first cover P121 and the second cover P122 is relatively complicated, leading to higher manufacturing cost.

The Chinese patent application with publication number CN221564357U, discloses a smart trash container with a dual-cover opening mechanism, which includes a lower bin body P2, a first cover P121 and a second cover P122, as shown in FIG. 15A and FIG. 15B. The first and second covers P121, P122 have the same width and disposed on a top surface of the lower bin body P2. The selectively opening and closing of the first and second covers P121, P122 are similar to the concepts and disadvantages of the '387U patent.

The main disadvantage of the above-mentioned '387U and '357U patents is that when the first and second covers P121, P122 are selectively closed and folded inwards, the bottom surfaces of the first and second covers P121, P122 will be crossed contaminated by the trash on the upper part of the trash container if the trash container is full of trash.

Referring to FIG. 16A and FIG. 16B, the Chinese patent application, publication number CN217893965U, discloses a trash cover with a dual-opening cover structure, which includes an upper bin body P1, a first cover P121 and a second cover P122. The first cover P121 and the second cover P122 are synchronously operated when selectively opened or closed. The exterior surface of the upper bin body P1 is defined as the surface of the four sides to define a inlet opening therein, wherein the first and second covers P121, P122 are folded inwardly and embedded in the corresponding inner sides of the inlet opening when the trash cover is selectively opened. The overall height of the trash container is almost the same as that of the bin body P1 when the covers P12, P122 are opened. However, the risk of both the trash covers P121, P122 being contaminated is greatly increased when both being opened for discarding trash via the inlet opening P13 and being closed for the inner surfaces of the first and second covers P121, P122 are exposed within the receiving chamber P14. Also, the first and second covers P121, P122 also reduce the capacity of the receiving chamber P14 because if the trash disposed in the receiving chamber P14 is accumulated to a height higher than the lower edges of the first and second covers P121, P122, the trash will block the first and second covers P121, P122 from flipping down and closing up. Furthermore, the first and second covers P121, P122 occupy much space of the inlet opening P13 that significantly makes the feeding opening P13 smaller.

Another unsolved drawback of the conventional dual-cover structure of the conventional trash containers is that the motorized driver and transmission mechanism is complicated for the requirement of opening and closing two covers P121, P122 at the same time. Such complicated linkage and transmission mechanism is easier to be damaged and unable to function properly and consumes more electrical power that reduces the span life of the batteries of the conventional motorized trash container.

### SUMMARY OF THE PRESENT INVENTION

The invention is advantageous in that it provides a single lid trash container equipped with a lid inward and downward flipping arrangement, which is configured for selectively opening and closing the single lid, to overcome the drawbacks and shortcomings of the conventional arts as mentioned in the background of the invention.

Another advantage of the invention is to provide a single lid trash container with a lid inward and downward flipping arrangement configured to significantly maximize the size of the inlet opening thereof while allowing the single lid to flip inwardly and downwardly to an open state and to flip down to a close state with respect to the inlet opening.

Another advantage of the invention is to provide a single lid trash container with lid inward and downward flipping arrangement, which ensures that the lower portion of the lid in the open state being hidden in the annular container cover will not exceed the bottom of the inner ring of the container cover, so that the rear end of the lid will not contact with the garbage or the trash received in the in the container body.

Another advantage of the invention is to provide a single lid trash container with lid inward and downward flipping arrangement, wherein the height of the annular container cover is fully utilized, wherein a rotation radius required for the opening of the lid is reduced and the space above the top of the container body that is occupied after the lid is opened is also reduced, such that the front end of the lid is not easy to contact with the user's hands during the opening and closing of the lid.

Another advantage of the invention is to provide a single lid trash container with lid inward and downward flipping arrangement, wherein the center of gravity after the lid is opened is lower than the hinged cover of the conventional trash container, that is especially important to the motorized trash container that is opened by battery. Accordingly, the power consumption when opening the lid of the present invention can be reduced and the service life of battery is prolonged.

Another advantage of the invention is to provide a single lid trash container with lid inward and downward flipping arrangement, which is configured to not only provide a more neat and pretty appearance but also strengthen an airtight performance by configuring a slant step edge at the rear end of the lid, arranged slightly lower than the upper surface of the lid, for hiding in the lower side of the upper surface of the annular container cover after the lid is closed, such that the gap between the junction of the rear end of the lid and the annular container cover is substantially blocked by the slant step edge.

Another advantage of the invention is to provide a single lid trash container with lid inward and downward flipping arrangement, wherein the connection between the slant step edge and the rear end of the container cover is connected in a inclined manner, so that the garbage and trash will slide more easily along the inclined plane into the container body in order to keep the lid clean relatively.

Another advantage of the invention is to provide a single lid trash container with lid inward and downward flipping arrangement, which annular container cover is configured to allow the single lid to be received inside an inner ring portion thereof in the proximity of a rear inner sidewall of the container cover to accommodate a rear end of the single lid into the inner ring portion when the single lid is selectively opened and flipped in an upright extending position.

Another advantage of the invention is to provide a single lid trash container with lid inward and downward flipping arrangement, which is configured to allow the upper portion of the single lid to be higher than the upper surface of the container cover, which reduces a flipping radius of the lib during opening and closing, and prevents the upper end of the single lid from easily hitting the user's hand or the trash in the user's hand.

Another advantage of the invention is to provide a single lid trash container with lid inward and downward flipping arrangement, which helps to minimize the space occupied above the trash container when the single lid is in the open state.

Another advantage of the invention is to provide a single-cover trash container to have a level detector for determining whether a height of trash contained in a receiving cavity of the trash cover exceeds a predetermined threshold height to prevent the single-cover from being contaminated when the single-cover is selectively closed.

Another advantage of the invention is to provide a single lid trash container with lid inward and downward flipping arrangement, wherein a center of gravity of the single lid is arranged to be lower than that of the conventional trash container, such that when the lid of the container cover is selectively opened, a power consumption of the low center of gravity of the single lid is lower than that of the conventional trash container that has a high center of gravity of the lid or cover, that can substantially extend the life of the battery of the single lid trash container of the present invention.

Another advantage of the invention is to provide a single lid trash container equipped with a lid inward and downward flipping arrangement which simplifies its transmission mechanism and minimizes its number of components so as to prolong the life span of the flipping mechanism, avoid malfunction of the opening and closing of the single lid, reducing the manufacturing cost of the trash container, and ensuring light, smooth and effective operation of the opening and closing of the single lid.

Additional advantages and features of the invention will become apparent from the description which follows and may be realized by means of the instrumentalities and combinations particular point out in the appended claims.

According to the present invention, the foregoing and other objects and advantages are attained by a trash container, comprising:

a container body having a receiving cavity therein and a body opening;

an annular container cover, having an inlet opening and an enclosure chamber, configured to be mounted on top of the container body to communicate the inlet opening with the body opening of the container body, wherein the container cover consists of a lid which is configured to be selectively flipped down to close the inlet opening and flipped up inwardly and downwardly to open the inlet opening; and a lid inward and downward flipping arrangement, received in the enclosure chamber of the container cover, configured to drive the lid to rotate about a flipping axis of the lid to selectively flip up the lid to an open state that the lid is positioned in an upright manner with only an upper portion of the lid extending above the container cover upwardly and a lower portion extending within the inlet opening of the container cover, and flip down the lid to a close state that the lid is positioned flatly to cover the inlet opening.

In one embodiment, in the open state, the lid is generally positioned adjacent to a rear inner sidewall of the container cover in the upright manner.

In one embodiment, in the close state, the upper surface of the lid is flatly supported at the same height with the top surface of the container cover.

In one embodiment, the container body comprises a bottom wall and a surrounding wall upwardly extending from the bottom wall to form the body opening and define the receiving cavity between the bottom wall and the bin opening.

In one embodiment, the container cover comprises a ring shape cover base, and a ring shape cover housing configured to be mounted on the cover base to define the inlet opening therein, wherein a rear inner sidewall, a front inner sidewall and left and right inner sidewalls are extended upwards from the cover base to the cover housing.

In one embodiment, two pivot holes are respectively formed in rear portions of two left and right inner sidewalls, adjacent to the rear inner sidewall, of the container cover such that the flipping axis is extended between the two pivot holes.

In one embodiment, the lid has two pivot axles protruded from rear portions of two sides thereof, which are configured to fittingly in the two pivot holes of the container cover along the flipping axis, such that the lid is capable of rotating about the flipping axis.

In one embodiment, the lid inward and downward flipping arrangement comprises a motor, a transmission mechanism arranged between the motor and one of the pivot axles to drive the lid to rotate about the flipping axis between the open state and the close state.

In one embodiment, the transmission mechanism comprises a gear set comprising a predetermined number of gears to transmit the power output of the motor to the pivot axle coupled thereto.

In one embodiment, the lid inward and downward flip arrangement further comprises a trigger-control driving circuit provided to control the motor and the gear set to selectively drive the lid to open and close.

In one embodiment, the trigger-control driving circuit comprises:

a trigger controller provided to trigger the transmission mechanism to selectively open and close the lid; and a level detector provided to detect a height of trash contained in the receiving cavity of the container body.

In one embodiment, the lid is shaped and sized to fittingly match the inlet opening of the annular container cover.

In one embodiment, the cover housing is shaped and sized to fittingly match the cover base to form the annular container cover.

In one embodiment, the body opening of the container body is configured to have a shape and a size to allow the container cover fittingly mounted thereon while the inlet opening of the container cover matching with the body opening of the container body so as to communicate the receiving cavity of the container body with outside through the inlet opening, wherein the lid is shaped and sized to selectively close the inlet opening in an airtight manner.

In one embodiment, the lid is pivotally mounted to the cover housing of the container cover by pivotally inserting into the two pivot holes of the cover housing, such that when the lid is rotated about the flipping axis to flip down towards the cover housing, the inlet opening is closed by the lid, and that when the lid is rotated about the flipping axis to flip up away from the cover housing, the inlet opening is opened.

In one embodiment, one of the pivot axles is configured to extend through the corresponding pivot hole to be rotatably and detachably coupled to the transmission mechanism as a driving pivot axle, while another pivot axle is pivotally connected with the corresponding pilot hole as a driven pivot axle.

In one embodiment, when the lid is opened, the rear end of the lid is flipped inwards and downwards until the lid is in an upright position and in the open state and the inlet opening is fully opened and communicated with outside, wherein in the upright position, the lower portion of the lid, having a width equal to or slight shorter than a height of the container cover, sinks inside the container cover and is positioned overlappingly with the rear inner sidewall of the container cover while only the upper portion of the lid is upwardly extended out of the inlet opening, such that the inlet opening has a maximum size communicating with outside in the open state, the front side of the trash container has nothing extending out to leave a clear and total opening space to the user, and only the upper portion of the lid is extended upwards adjacent to the rear inner sidewall of the container cover to avoid hitting the user's hands. Accordingly, such an arrangement makes full use of the height of the container cover, reduces the rotation radius of the lid during opening and closing, maximize the space above the trash container after the lid is opened that effectively prevents the user's hand from contacting the lid.

In one embodiment, the trigger-control driving circuit is configured to drive the transmission mechanism to selectively open and close the lid when a driving signal is transmitted from the trigger-control driving circuit to the transmission mechanism, wherein the container cover is selectively opened when the motor rotates in one direction, and the lid is selectively closed when the motor rotates in an opposite direction.

In one embodiment, when the container cover is selectively opened, the lower portion of the lid is allowed to be sunk into a ring inner portion of the container cover while the upper portion of the lid upwardly extends out of a top surface of the container cover to provide a maximized inlet opening at the top surface of the container cover.

In one embodiment, the container cover is configured to have an inner ring base to allow the pivot end of the lid to rest on the inner ring base when the lid is selectively opened.

In one embodiment, the pivot holes are positioned at rear portions of the left and right inner sidewalls of the container cover, and that a distance between each of the axle holes and the upper surface of the lid in the close state is less than or equal to a distance of each of the pivot holes to the rear inner sidewall of the container cover, so that the lid can be opened to the upright position to maximize the size of the inlet opening.

In one embodiment, the pivot holes are positioned at rear portions of the left and right inner sidewalls of the container cover, and that a distance between each of the axle holes and the rear inner sidewall is smaller than or equal to a distance between each of the pivot axles and a bottom end of the container cover, so that when the lid is in the open state, the lower portion of the lid sinks in the inner ring base of the container cover, so that the lower portion of the lid is ensured to be hidden in the inner ring base and will not extend beyond the bottom end of the container cover during the open state, that not only keeps the lid clean but also avoids any contact with the garbage and trash in the receiving cavity of the container body.

In one embodiment, when the lid is in the close state, a distance between each of the pivot holes and the rear inner sidewall of the container cover is slightly smaller than a distance between each of the pivot holes to the inner ring base, that allows the lower portion of the lid to be hidden in the container cover to reduce an overall height of the trash container in the open state, facilitating the trash container to be placed against a wall.

In one embodiment, when the lid is in the close state, a distance between each of the pivot holes and the rear inner sidewall of the container cover is slightly smaller than a distance between each of the pivot holes to the inner ring base, so that a smaller swing radius is required for the lid while reducing overhead space during the open state, that substantially reduces a risk of hitting a user's hand or the trash in the user's hand during the opening or closing movement of the lid.

In one embodiment, the lid is integrally provided with a slant step edge downwardly extending along the rear end thereof in such a manner that a top surface of the slant step edge is slightly lower than the top surface of the container cover, so that when the lid is in the close state, the slant step edge is arranged to be positioned and hidden under the top surface of the container cover, adapted to avoid a gap formed at a conjunction between the lid and the container cover to enhance a sealing performance of the lid, wherein an aesthetic appearance of the trash container is ensured too.

In one embodiment, the slant step edge of the lid is extending downwardly along its rear end, wherein such sunken arrangement ensures the slant step edge being positioned slightly lower than the upper surface of container cover in the close state and hidden in the a lower side of the top surface of container cover, which significantly improves the shortcoming of the conventional trash container that, in order to make the appearance of the trash container more beautiful, the rotating shaft of the lid is often arranged at a position below the container cover, so that the rear end of the lid is required to form a relatively larger gap space to meet the flipping motion for opening and closing the lid and thus the rear end of the barrel cover is not tightly covered. The slant step edge configuration of the present invention allows the slant step edge of lid being hidden in the lower side of the top surface of the container cover after the lid is closed that just fittingly blocks the gap between the rear end of the lid and the junction of the container cover and strengthens the airtight performance of the trash container.

In one embodiment, the slant step edge is configured to have a gradient transition therealong to allow the garbage and trash to be easily disposed into the receiving cavity of the container body through the inlet opening so as to keep the container cover clean.

In one embodiment, a reflective infrared sensor generates a driving signal to trigger the transmission mechanism to selectively open and close the lid when an object (such as a hand) is detected within a detection zone.

In one embodiment, a vibration sensor can be provided and configured to generate a driving signal to trigger the transmission mechanism to selectively open and close the lid when vibration (such as clapping) or movement (such as kicking) is detected.

In one embodiment, a touch sensor can be provided and configured to generate a driving signal to trigger the transmission mechanism to selectively open and close when physical contact or pressure is detected.

In one embodiment, at least two sensors selected from a group consisting of a vibration sensor, a reflective infrared sensor, a touch sensor and other trigger sensors, generates a driving signal to trigger the transmission mechanism to selectively open and close when detected.

In one embodiment, the level detector is provided to detect a predetermined threshold height of trash contained in the receiving cavity of the trash container, wherein the predetermined threshold height of the trash is set to be lower than a height of the cover housing of the container cover from the bottom wall of the trash container to a bottom surface of the cover housing.

In one embodiment, the driving signal generated from the trigger controller is provided to the transmission mechanism to selectively open and close the container cover when the height of the trash in the receiving cavity, as detected by the level detector, is lower than the predetermined threshold height, wherein the driving signal stops triggering the transmission mechanism to selectively open and close the container cover when it is detected that the height of the trash in the receiving cavity exceeds the predetermined threshold height.

In accordance with another aspect of the invention, the present invention provides an operation process of selectively opening and closing a lid of a trash container, including steps of:
(a) driving the lid to flip inwards and downwards about a flipping axis to an open state by a lid inward and downward flipping arrangement, wherein the lid is in an upright position adjacent to an rear inner sidewall of a container cover mounted on a container body having a receiving cavity therein so as to communicate the receiving cavity with outside through an inlet opening of the container cover, while a lower portion of the lid, having a width less than or equal to a height of the container cover, sinks in the container cover and only an upper portion of the lid extends upwardly from a top surface of the container cover; and
(b) driving the lid to flip up about the flipping axis to a close state by the lid inward and downward flipping arrangement, wherein the lid is flatly positioned on the top surface of the container cover to close the inlet opening.

In one embodiment, the step (a) and step (b) of the operation process is controlled by a control method comprising steps of:
(1) sending an instruction to emit a driving signal when a user is intended to throw trash into the trash container;
(2) generating the driving signal from a trigger controller when the instruction is received from the user; and
(3) determining whether a height of the trash in a receiving cavity of the trash container exceeds a predetermined threshold height by a level detector, wherein the driving signal is indirectly transmitted to execute the step (a) when the height of trash is lower than the predetermined threshold height, wherein an action signal generated from the level detector is sent to not execute the step (a) when the height of trash exceeds the predetermined threshold height.

In one embodiment, in the step S1, the instruction is selected from a group consisting of a movement, a physical touch, kicking and other actions that can activate the trigger controller.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a trash container in close state according to a preferred embodiment of the present invention.

FIG. 2 is a perspective view of the trash container in open state according to the above preferred embodiment of the present invention.

FIG. 3 is an exploded perspective view of the trash container according to the above preferred embodiment of the present invention.

FIG. 4 is an exploded perspective view of a container cover and the lid of the trash container according to the above preferred embodiment of the present invention.

FIG. 5 is a perspective view of the container cover of the trash container according to the above preferred embodiment of the present invention.

FIG. 6 is a perspective view of the lid of the trash container according to the above preferred embodiment of the present invention.

FIG. 7 is an exploded perspective view illustrating the lid and the lid inward and downward flipping arrangement of the trash container according to the above preferred embodiment of the present invention.

FIG. 8 is a cross-sectional view of the container cover of the trash container with the lid in open state according to the above preferred embodiment of the present invention.

FIG. 9 is a cross-sectional view of the container cover of the trash container with the lid in close state according to the above preferred embodiment of the present invention.

FIG. 10 is a partial cross-sectional view illustrating a lower portion of the lid in open state with respect to the rear portion of container cover of the trash container according to the above preferred embodiment of the present invention.

FIG. 11 is a block diagram illustrating a control module of the trash container according to the above preferred embodiment of the present invention.

FIG. 12 is a block diagram illustrating a control method of the trash container according to the above preferred embodiment of the present invention.

FIG. 13A is a perspective view of a first conventional trash container.

FIG. 13B is perspective view illustrating the container cover of the first conventional trash container.

FIG. 14A is a perspective view of a second conventional trash container.

FIG. 14B is a perspective view illustrating the dual-cover container cover of the second conventional trash container.

FIG. 15A is a perspective view of a third conventional trash container in open state.

FIG. 15B is a perspective view of the third conventional trash container in close state.

FIG. 16A is a perspective view of a fourth conventional trash container.

FIG. 16B is a perspective view of the container cover of the fourth conventional trash container in open state.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

In the description of the present invention, unless explicitly stated otherwise and qualified, terms such as “connected,” “attached,” and “fixed” should be construed broadly. For instance, these terms may indicate a permanent connection or a detachable one, or they may refer to a whole unit. They can signify a mechanical linkage, an electrical connection, direct coupling, or indirect interaction through an intermediary medium. Whether these terms imply an internal connection between two elements or an interactive relationship between them will depend on the specific context and the understanding of those skilled in the art.

Throughout this invention, unless explicitly stated otherwise and qualified, when the first feature is described as being “above” or “below” the second feature, this may entail direct physical contact between the two features. Alternatively, it may signify that the first and second features are not in direct contact but are linked through the involvement of additional features. Additionally, the description of the first feature being “above,” “over,” or “on top of” the second feature includes scenarios where the first feature is positioned directly above or diagonally above the second feature or simply means that the first feature is situated at a higher horizontal level than the second feature. Conversely, when the first feature is referred to as “below,” “under,” or “beneath” the second feature, it encompasses cases where the first feature is directly below or diagonally below the second feature or simply implies that the first feature's horizontal height is less than that of the second feature.

In this embodiment's description, terms such as “up,” “down,” “right,” and “left” are used to describe orientations or positional relationships. These descriptions are based on the orientations or positions depicted in the drawings and are employed for ease of explanation and simplification of operation. They should not be construed as indications or implications that the device or element being discussed must possess a specific orientation, be constructed in a particular manner, or operate exclusively in a certain orientation. Furthermore, terms such as “first” and “second” are employed solely for the purpose of distinction in the description and do not carry any particular significance.

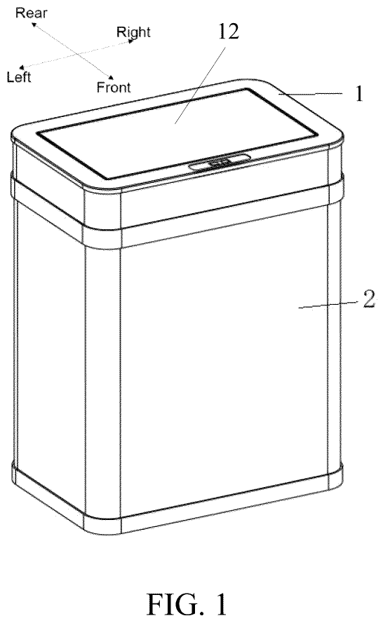

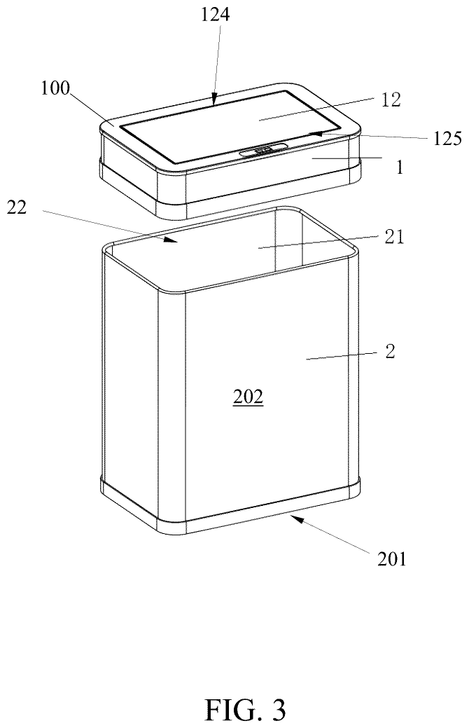

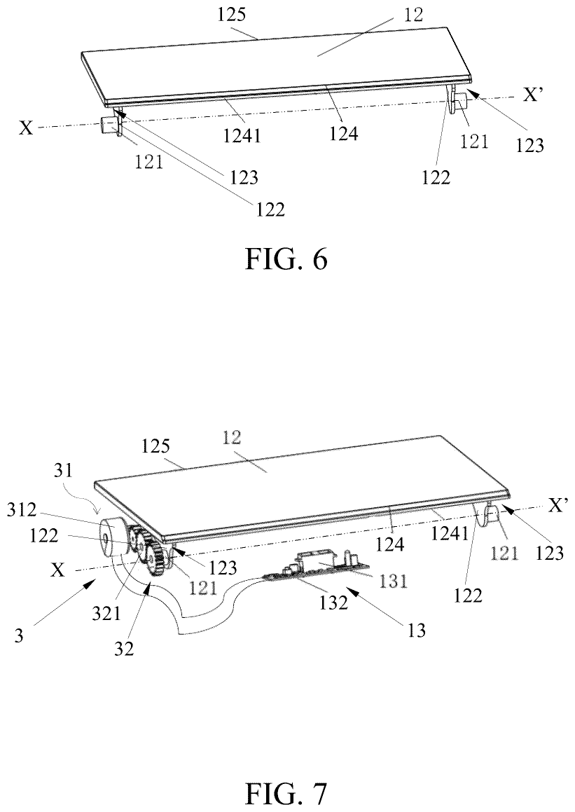

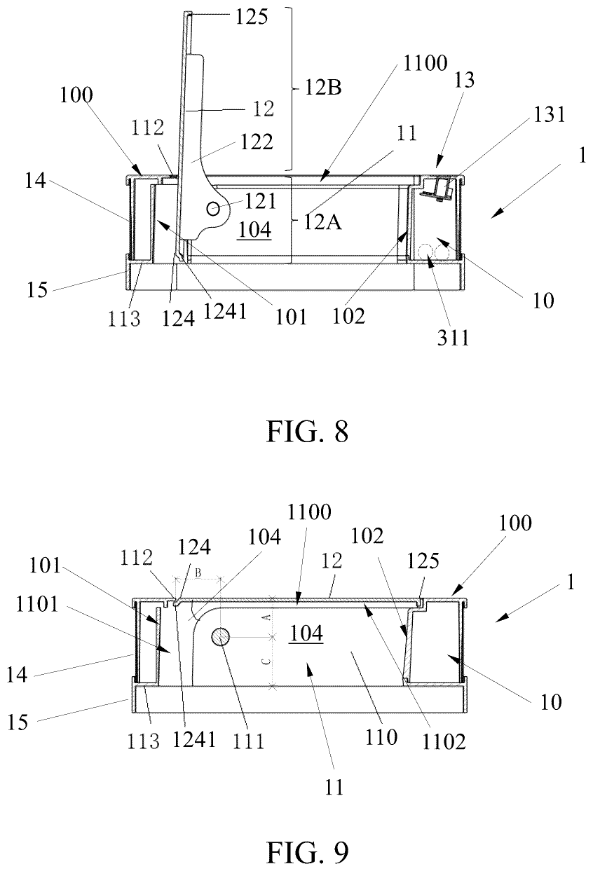

Referring to FIG. 1 to FIG. 12 of the drawings, a trash container according to a preferred embodiment of the present invention is illustrated, wherein the trash container comprises a container body 2 having a receiving cavity 21 defined therein and a body opening 22 for communicating the receiving cavity 20 with outside (as shown in FIG. 3), a container cover 1 configured to be mounted on top of the container body 2 and defining an inlet opening 11 therein to coaxially communicate with the body opening 22 of the container body 2, wherein the container cover 1 consisting of a single lid 12 configured to be selectively driven between a close state (as shown in FIG. 9) to fittingly and fully cover the inlet opening 11 and an open state (as shown in FIG. 8) to fully open the inlet opening 11.

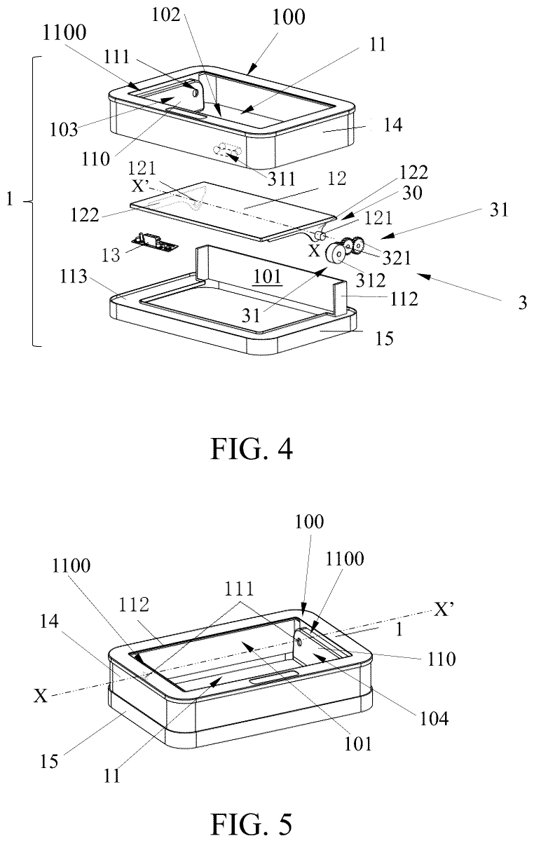

The trash container further comprises a lid inward and downward flipping arrangement 3 (as shown in FIG. 4) to equip with the lid 12 to achieve the objectives including, but not limited to, maximizing the size of the inlet opening 11 while allowing the single lip 12 to flip inwardly and downwardly to the open state and to flip down to the close state with respect to the inlet opening 11; fully utilizing a heigh of the container cover 1 to hide at least a rear portion 121 of the lid 12 in the open state in the container cover 1 and will not contact with the trash received in the receiving cavity 21 of the container body 2 of the trash container; reducing the height of the lid 12 extended above the container body 2 in the opened state; ensuring an airtight performance of the lid 12 with respect to the container cover 2 in the close state; and avoiding any portion of the lid extending at the front side of the trash container in the open state to prevent the trash to be disposed and the user's hands from contacting the lid 12 to avoid hitting the user's hands and contaminate the lid 12 by the trash.

According to the preferred embodiment, referring to FIG. 8 and FIG. 9, the container cover 1 of trash container has an annular configuration that defines a ring-shape enclosure chamber 10 therein, wherein the lip 12 is configured to selectively flipping down to close the inlet opening 11, as shown in FIG. 9, and flipping inwardly and downwardly to open the inlet opening 11, as shown in FIG. 8.

According to the preferred embodiment, the lid 12 is pivotally connected to the container cover 1, wherein an exterior surface of the container cover 11 is defined as four surfaces of four sides thereof, and that the lid 12 is shaped and sized to fittingly match a size and a shape of the inlet opening 11 of the container cover 1.

The lid inward and downward flipping arrangement 3 is received in the enclosure chamber 10 and configured to pivotally transmit a rotation about a flipping axis X-X′ of the lid 12 to selectively flip up the lid 12 to the open state that the lid 12 is positioned in an upright manner with only an upper portion 12B of the lid 12 extending above the container cover 1 upwardly and the lower portion 12A extending within the inlet opening 11 of the container cover 1 (as shown in FIG. 8), or flip down the lid 12 to the close state that the lid 12 is flatly supported at the same heigh with a top surface 100 of the container cover 1 to cover the inlet opening 11 (as shown in FIG. 9).

As shown in FIG. 3, the container body 2 has a bottom wall 201 and a surrounding wall 202 upwardly extended from the bottom wall 201 to define the body opening 22 and a receiving cavity 21 between the bottom wall 201 and the body opening 22 therein, wherein container body 2 is provided to allow the container cover 1 to be positioned on top of the body opening 22 thereof.

Referring to FIG. 4 and FIG. 5, the annular container cover 1 comprises a cover housing 14 and a cover base 15, wherein the cover housing 14 is a housing frame and the cover base 15 is configured as a bottom frame to allow the cover housing 14 to be securely mounted thereabove. The cover base 15 has a rear wall 112 upwardly extended and a top surface of the cover base 15 for an inner ring base 113. The cover housing 14 is shaped and sized to fittingly match to the cover base 15 to affixedly connect with each other to form the annular container cover 1, defining the enclosure chamber 10 between the cover housing 14 and the cover base 15.

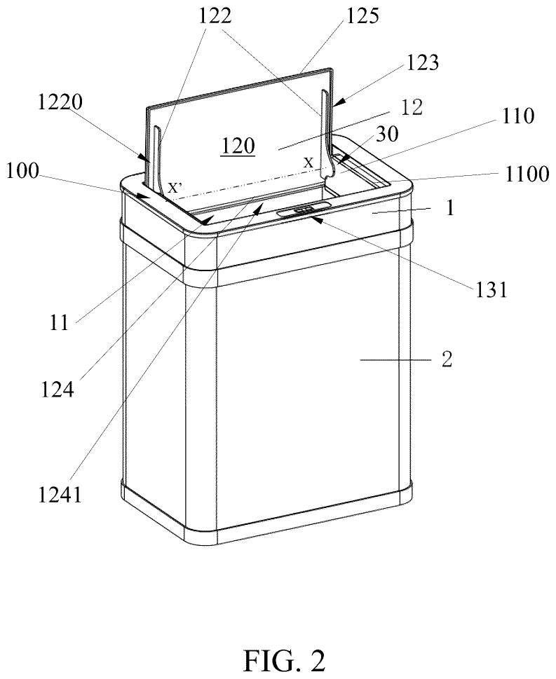

The lid inward and downward flipping arrangement 3 includes a lid pivot device 30 for pivotally connecting the lid 12 to the container cover 1, as shown in FIG. 2 and FIG. 4, wherein the lid pivot device 30 comprises a pair of pivot axles 121 integrally protruded on a pair of support wings 122 respectively and a pair of lid support bases 110. The pair of support wings 122 is respectively and downwardly extended from two side portions of a bottom surface 120 of the lid 12 symmetrically and integrally while two lid supporting edges 123 are defined between the two support wings 122 and the two side edges of the lid 12 respectively.

Referring to FIGS. 2, 4-5 and 8-9, the pair of the lid support bases 110 is integrally and inwardly protruded from left and right inner side surfaces of the container cover 1 respectively, wherein the rear wall 112 of the cover base 15, an inner front wall of the cover housing 14, and the left and right lid support bases 110 form a rear inner sidewall 101, a front inner sidewall 102 and left and right inner sidewalls 103, 104 of the container cover 1 respectively.

As shown in FIG. 9, each of the pair of the lid support bases 110, having a predetermined thickness, is extended the front inner sidewall 102 rearwardly towards the rear inner sidewall 101, defining a rear groove 1101 between the rear inner sidewall 101 and a rear end of the lid support base 110 and a top groove 1102 between the corresponding lid support base 110 and the top surface 100 of the container cover 1, such that an upper surface of each of the lid support bases 110 forms a lid support surface 1100 for supporting the two lid supporting edges 123 of the lid 12. It is appreciated that a height of each of the top grooves 1102 is preferably equal to a thickness of the lid 12 and a thickness of each of the lid support bases 10 is equal to or larger than a width of each of the lid supporting edge 123 of the lid 12, such that the lid 12 is able to be flatly supported on the container cover 1 while the two lid supporting edges 123 are fittingly sat on and supported by the two lid support surfaces 1100 of the two lid support bases 110 respectively, so that the lid 12 is closed in the close state to fittingly cover the inlet opening 11, as shown in FIG. 1 and FIG. 9.

Corresponding to the pair of the pivot axles 121 of the lid pivot device 30, a pair of pivot holes 111 is formed in the pair of the lid support bases 110 respectively. According to the preferred embodiment, the pair of pivot holes 111 is formed at symmetrical rear portions of the pair of the lid support bases 110 coaxially and respectively. Correspondingly, each of the pair of pivot axles 121 is also protruded on rear portions of the pair of the support wings 122 of the lid 12 respectively, such that a distant between the upper surface of the lid 12 and a centre of each of the pivot axles 121 is preferred to be equal to a distant between the top surface 100 of the container cover 1 and a centre of each of the pivot holes 111. In other words, the flipping axis X-X′ is defined between the two pivot axles 121 and the two pivot holes 111. The two pivot holes 111 are shaped and sized for the two pivot axles 121 rotatably inserted therein respectively, such that the lid 12 is able to pivotally flip up to the open state and flip down to the close state about the pair of pivot holes 111, i.e. the flipping axis X-X′, with respect to the container cover 1.

According to the preferred embodiment of the present invention, referring to FIG. 4 and FIG. 7, the lid inward and downward flipping arrangement 3 further comprise a power source 31 and a transmission mechanism 32. The power source 31 includes an electrical (AC or DC) power source embodied as one or more batteries 311 and a mechanical power source embodied as a motor 312 electrically connected to the batteries 311 to supply a rotation power output to the transmission mechanism 32 to drive one of the pair of pivot axles 121 of the lid 12 to rotate about the flipping axis X-X′. The power source 31, including the batteries 311 and the motor 312, and the transmission mechanism 32 are installed in the receiving chamber 10, wherein one of the pivot axles 121 of the lid 12 is configured to extend through the corresponding pivot hole 111 of the container cover 11 to be moveably and detachably coupled to the transmission mechanism 32 which reduces a rotation speed of the rotation power output of the motor 312 and rotates the coupled pivot axles 121 about the flipping axis X-X′ to drive the lid 12 to selectively flip up to the open state or flip down to the close state. The pivot axle 121 coupled with the transmission mechanism 32 acts as a driving pivot axle while the other pivot axle 121 which is merely rotatably inserted in the corresponding pivot hole 111 acts as a driven pivot axle.

It is worth mentioning that, in an alternative mode of the preferred embodiment, the power source 31 can be embodied to only include the mechanism power source 312 which can be a foot pedal while the transmission mechanism 32 can be embodied as a linking mechanism to transmit the foot step motion to the rotation motion of the driving pivot axle 121. In other words, the lid inward and downward flipping arrangement of the present invention can be embodied as a mechanical actuation instead of the electric actuation.

Referring to FIG. 4 and FIG. 7, the transmission mechanism 32 comprises a gear set 321 comprising a predetermined number of gears, including an input gear coupled with an output shaft of the motor 312 and an output gear coupled with the driving pivot axle 121.

As shown in FIG. 7 and FIG. 11, the trash container further comprises a trigger-control driving circuit 13, configured to be electrically connected to the transmission mechanism 32, for controlling the lid 12 to selectively open and close via the transmission mechanism 32, wherein the trigger-control driving circuit 13 comprises a trigger controller 131 for triggering the transmission mechanism 32 to selectively open and close the lid 12, and a level detector 132 for detecting a height of trash contained in the receiving cavity 21 of the container body 2.

According to the preferred embodiment, the trigger controller 131 is embodied as a reflective infrared sensor 1312 configured to control the motor 312 and the transmission mechanism 32 to selectively drive the lid 12 to flip up to the open state or to flip down to the close state. When an object such as a hand or a garbage is placed within a detection range of the reflective infrared sensor 131, the reflective infrared sensor 131 is triggered after receiving reflected signal, and the trigger-control driving circuit 13 controls the opening and closing of lid 12 through the transmission mechanism 32.

In other words, the trigger-control driving circuit 13 is configured to trigger the transmission mechanism 32 to drive the lid 12 to selectively flip up to the open state and to flip down to the close state when a driving signal is transmitted from the trigger-control driving circuit 13 to the transmission mechanism 32. The lid 12 is selectively opened when the motor 312 and the transmission mechanism 32 drive the driving pivot axle 121 to rotate in one direction, and the lid 12 is selectively closed when the motor 312 and the transmission mechanism 32 drive the driving pivot axle 121 to rotate in an opposite direction.

Referring to FIG. 11, the trigger-control driving circuit 13 may further comprise a level detector 132 configured for detecting a height of trash contained in the receiving cavity 21 of the container body 2.

In order to reduce the overall height of the trash container when the lid 12 is opened, referring to FIG. 9, the pivot axles 121 and the pivot holes 111 are formed below the top surface 100 of the container cover 1 for a predetermined distance and in front of the rear inner wall 101 of the container cover 1 for a predetermined distance, such that when the lid 12 is selectively closed in the close state, a rear end 124 of the lid 12 is positioned in a proximity of the rear inner sidewall 101 of the container cover 1, and a front end 125 of the lid 12 is positioned in a proximity of the front inner sidewall 102 of the container cover 1.

According to the preferred embodiment, as shown in FIG. 8 and FIG. 9, it is preferred that a distance A between each of the pivot holes 111 (the flipping axis X-X′) to an upper surface of the lid 12 is smaller than a distance B between each of the pivot holes 111 (the flipping axis X-X′) to the rear inner sidewall 101. Such arrangement allows the lid 12 to extend vertically in an upright manner in the open state as shown in FIG. 8. In addition, the distance B between each of the pivot holes 111 (the flipping axis X-X′) and the rear inner sidewall 101 is slightly smaller than a distance C between each of the pivot holes 111 (the flipping axis X-X′) to a bottom of the inlet opening 11, i.e. the inner ring base 113. That is the lower portion 12A of the lid 12 is the portion of the lid 12 extended from the pivot axle 121 to the rear end 124 of the lid. Such arrangement allows the lower portion 12A of the lid 12 to be positioned and hidden in the inlet opening 11 of the container cover 1 to reduce an overall height of the trash container of the present invention in the open state, as shown in FIG. 8, and that when the lid 12 is flipped down along the flipping axis X-X′ to the close state, as shown in FIG. 9, the lid 12 is capable of flatly placing at the same plane of the top surface 100 of the container cover 1 while the two lid supporting edges 123 of the lid 12 are supported on the two lid support surfaces 1100 of the two lid support bases 110 of the container cover 1 respectively. It is worth mentioning that a smaller swing radius of the lid 12 is preferred, so as to reduce overhead space when selectively opened and also allows to reduce a risk of hitting a user's hand or the trash in the user's hand when the lid 12 is selectively opened or closed.

As shown in FIG. 2 and FIG. 8, it is noted that when the lid 12 is selectively opened, the rear end 124 as well as a lower portion 12A of the lid 12 position in the inlet opening 11 and adjacent to rear inner sidewall 101 of the container cover 11, and only the upper portion 12B and the front end 125 of the lid 12 vertically extends above the top surface 100 of the container cover 11, defining a trash feeding opening to be maximized at the top surface 100 of the container cover 11.

It is appreciated that the L shape configuration between the lid supporting edge 123 of the lid 12 and the lid support surface 1100 of the lid support base 110 of the container cover 1 not only well supports the lid 12 in a balance manner and maximizes the opening space of the inlet opening 11 of the container cover 1, but also provides a better airtight configuration for preventing fluid from outside to enter the inlet opening 11 nor the air and smell in the receiving cavity 21 of the container body 2 leaking outside when the lid 12 in the close state. The airtight configuration can further be enhanced by providing sealing pads attached on the two lid supporting edges 123 and/or the two lid support surfaces 1100 respectively.

In order to overcome the drawback of the conventional trash container that a gap is generally formed at the junction of the container cover and the lid, referring to FIG. 5 to FIG. 10, the lid 12 of the trash container according to the preferred embodiment of the present invention is integrally provided with a slant step edge 1241 downwardly extending along the rear end 124 thereof, wherein when the lid 12 is in the close state (as shown in FIG. 9), the slant step edge 1241 is downwardly and rearwardly extended to a position slightly lower than the upper surface of the lid 12 and the top surface 100 of the container cover 1, such that the slant step edge 1241 is positioned below and hidden under the top surface 100 of the annular container cover 11 that significantly covers a gap formed at the junction of the rear end 124 of the lid 12 and the top surface 100 of the container cover 11, without blocking the flipping up and down motions of the lids 12, enhances a sealing performance of the lid 12, and improves the aesthetic appearance of the trash container.

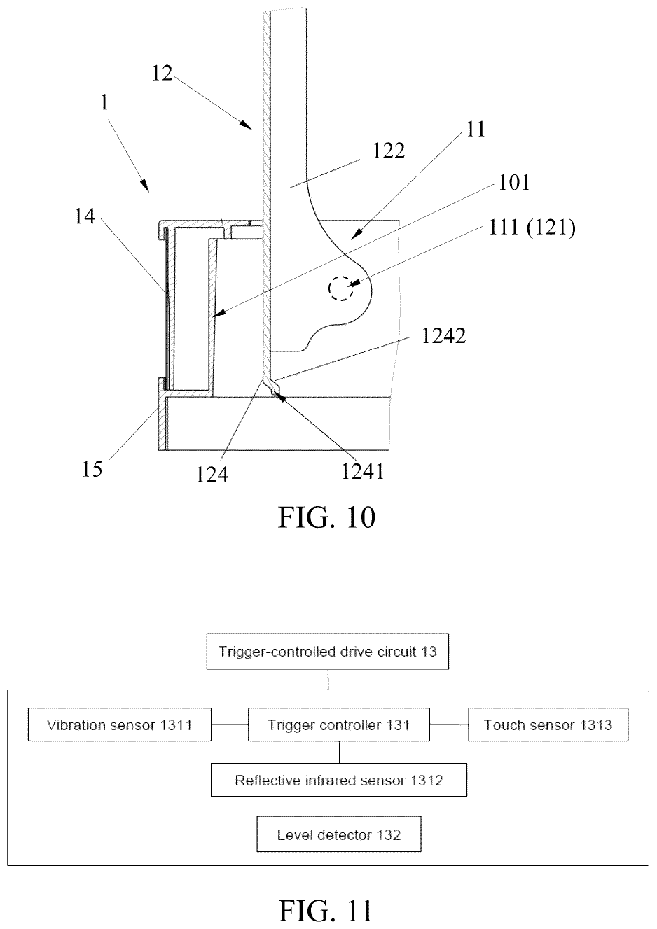

To the conventional trash container, garbage and trash are easily stuck in the gap formed between the container cover and the lid thereof, which would accumulate contaminant and breed bacteria. To avoid such situation, referring to FIG. 10, the slant step edge 1241 according to the preferred embodiment is embodied to have a gradient transition 1242 along the slant step edge 1241 to allow the garbage and trash to easily fall into the receiving cavity 21 of the trash container due to gravity while it is easier to keep the lid clean.

It is worth mentioning that a centre of gravity of the lid 12 of the present invention is configured to be lower than that of the conventional trash container during the open state so as to extend the life of the batteries 311 because a power consumption of the lid 12 with the low center of gravity is lower than that of the conventional lid of the conventional trash container with higher center of gravity during the open state.

Referring to FIG. 11, according to the preferred embodiment, the trigger controller 131 is embodied as the reflective infrared sensor 1312, which generates a driving signal to trigger the transmission mechanism 32 to selectively open and close the lid 12 when an object (such as a hand) is detected within a detection zone. It is appreciated that the trigger controller 131 of the trigger-control driving circuit 13 can also be embodied as a vibration sensor 1311, a touch sensor 1313. When the vibration sensor 1311 is used as the trigger controller 131, it generates a driving signal to trigger the transmission mechanism 32 to selectively open and close the lid 12 when vibration (such as clapping) or movement (such as kicking) is detected. When the touch sensor 1313 is embodied as the trigger controller 131, it generates a driving signal to trigger the transmission mechanism 32 to selectively open and close when physical contact or pressure is detected. It should be noted that the trigger controller 131 can be embodied to have at least two sensors selected from a group consisting of a vibration sensor 1311, a reflective infrared sensor 1312, a touch sensor 1313 and other trigger sensors according to the manufacturer's specifications.

According to the preferred embodiment, the level detector 132 is preferred to be provided to detect a predetermined threshold height of trash contained in the receiving cavity 21 of the trash container, wherein the predetermined threshold height of the garbage and/or trash is preferably to be set lower than a height of the cover housing 14 of the container cover 1 from the bottom wall of the trash container to a bottom surface of the cover housing 14.

Further, the driving signal generated from the trigger controller 131 is sent to the transmission mechanism 32 to selectively open and close the lid 12 when the height of the garbage and/or trash in the receiving cavity 21, as detected by the level detector 132, is lower than the predetermined threshold height. However, the driving signal stops triggering the transmission mechanism 32 to selectively open and close the lid 12 when it is detected that the height of the garbage and/or trash in the receiving cavity 21 exceeds the predetermined threshold height. The driving signal generated can be restored to trigger the transmission mechanism 32 to selectively open and close the lid 12 when the garbage and/or trash in the receiving cavity 21 is processed until the height of the trash in the receiving cavity 21 is lower than the predetermined threshold height. Accordingly, a bottom surface of the lid 12 is protected from a risk of trash contamination when selectively closed in such manner by applying of the level detector 132.

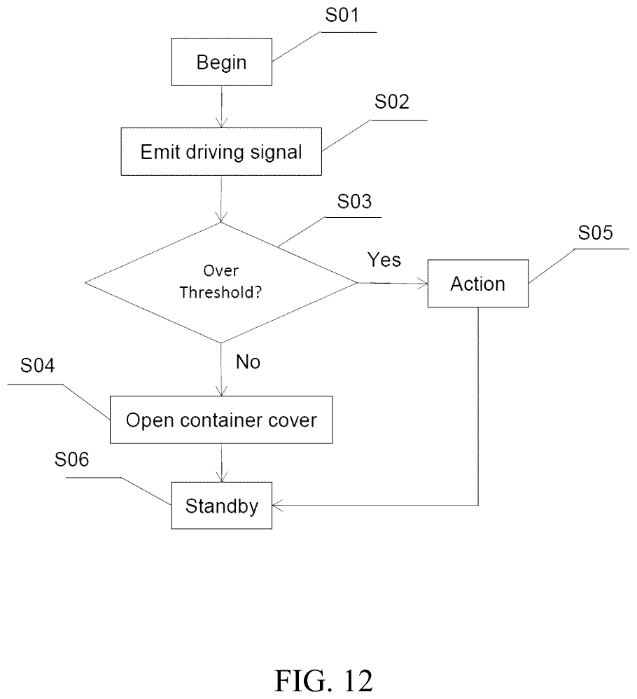

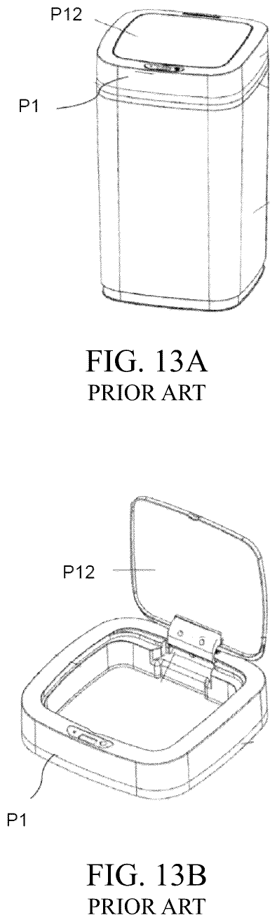

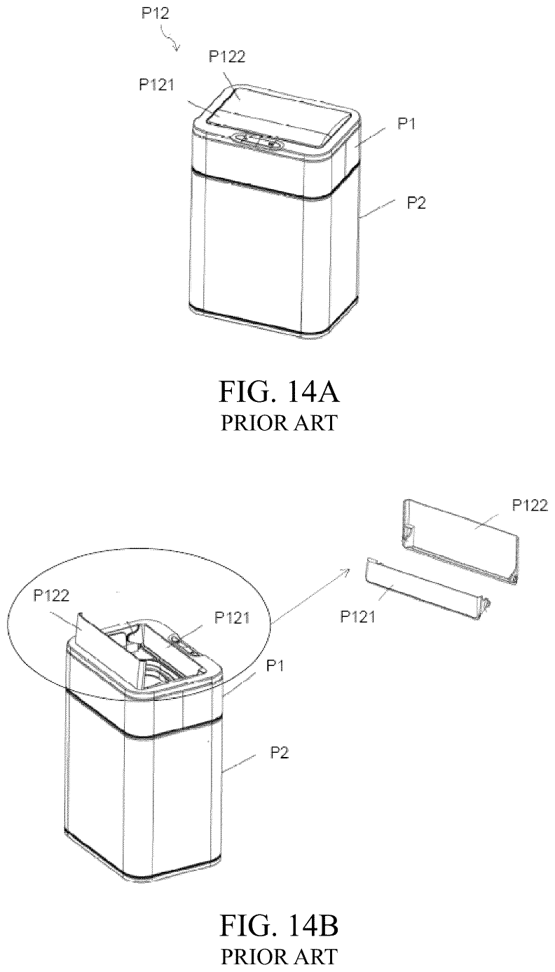

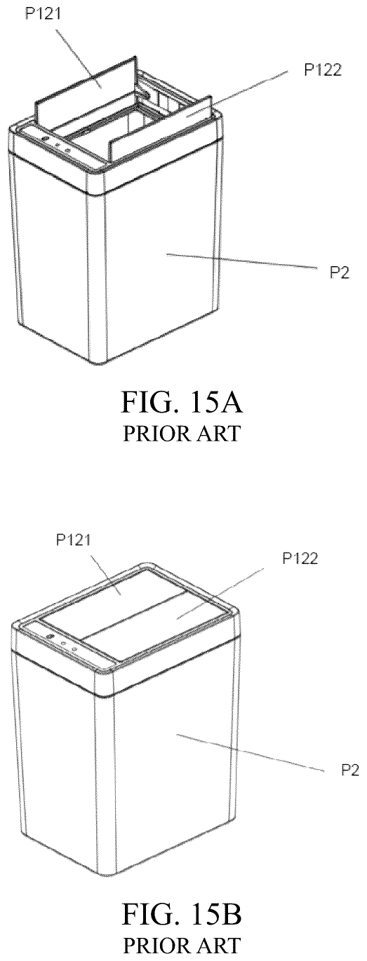

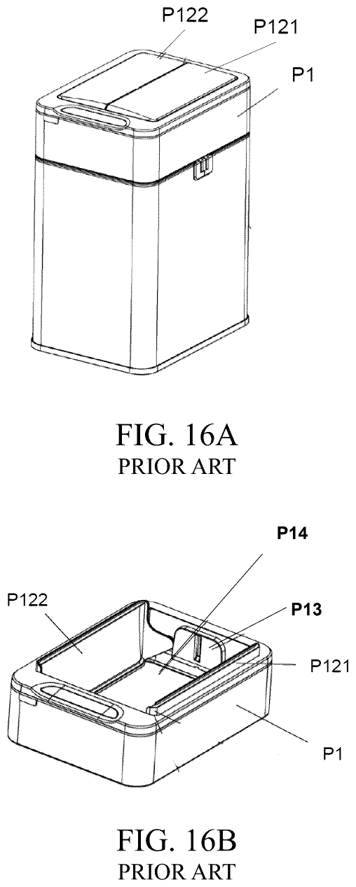

Referring to FIG. 12, in view of the user, an operation process of selectively opening and closing the lid 12 of the trash container is illustrated, in which the following steps are executed:

Step S01: A user starts to send an instruction to step S02 when the user intends to throw trash into the trash container, wherein the instruction is selected from a group consisting of a movement, a physical touch, kicking and other actions that can activate the trigger controller 131.

Step S02: The trigger controller 131 generates a driving signal to the Step S03 when the instruction is received from the user.

Step S03: The level detector 132 determines whether the height of trash in the receiving cavity of the trash container is higher than the predetermined threshold height, wherein the driving signal is indirectly transmitted to Step S04 when the height of trash is lower than the predetermined threshold height, wherein an action signal generated from the level detector 132 is sent to Step S05 when the height of trash exceeds the predetermined threshold height.

Step S04: The transmission mechanism 32 is triggered to selectively open the lid 12 to throw the trash into the receiving cavity of the trash container, wherein the lid 12 is closed through the transmission mechanism 32 when the trash is thrown away and the user leaves the trash container.

Step S05: Processing the trash in the receiving cavity until the height of the trash in the receiving cavity is lower than the predetermined threshold height.

Step S06: Completed the entire operation process and repeat steps S01 to S05 in the next cycle operation process.

In another aspect of the present invention, in view of the structure of the trach container as described above, the operation process of selectively opening and closing the lid 12 of the trash container includes steps of:
(a) driving the lid 12 to flip inwards and downwards about the flipping axis X-X′ to the open state by the lid inward and downward flipping arrangement 3, wherein the lid 12 is in an upright position adjacent to the rear inner sidewall 101 of the container cover 1 mounted on the container body 2 having the receiving cavity 21 therein so as to communicate the receiving cavity 21 with outside through the inlet opening 11 of the container cover 1, while the lower portion 12A of the lid 12, having a width less than or equal to a height of the container cover 1, sinks in the inlet opening 11 of the container cover and only the upper portion 12B of the lid 12 extends upwardly from the top surface 100 of the container cover 1; and
(b) driving the lid 12 to flip up about the flipping axis X-X′ to the close state by the lid inward and downward flipping arrangement 3, wherein the lid 12 is flatly positioned on the top surface 100 of the container cover 1 to close the inlet opening 11.

Further, the step (a) and step (b) of the operation process is controlled by a control method comprising steps of:
(1) sending an instruction to emit a driving signal when a user is intended to throw trash into the trash container;
(2) generating the driving signal from the trigger controller 131 when the instruction is received from the user; and
(3) determining whether a height of the trash in a receiving cavity 21 of the trash container exceeds the predetermined threshold height by the level detector 132, wherein the driving signal is indirectly transmitted to execute the step (a) when the height of trash is lower than the predetermined threshold height, wherein an action signal generated from the level detector 132 is sent to not execute the step (a) when the height of trash exceeds the predetermined threshold height.

In the step (1), the instruction is selected from a group consisting of a movement, a physical touch, kicking and other actions that can activate the trigger controller.

Compared with the conventional trash container, the trash container of the present merely consists of a single lid 12, which is simple in structure and low in cost, while the height space of the container cover 1 is fully utilized for sinking the lower portion 12A of the lid 12 therein to reduce the overall heigh of the trash container when opened. Also, the arrangement of the lower portion 12A of the lid 12 hidden in the container cover 1 can substantially reduce the rotation radius of the up flipping opening movement of the lid 12, that ensure the lid 12 is not easy to contact the user's hands or trash during the flipping up to open and flipping down to close of the lid 12. At the same time, the center of gravity of the lid 12 in the open state is lower than that of the conventional dual-lid trash container, which can reduce the power consumption when opening the lid 12 and prolong the service life of the batteries 311.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1-20. (canceled)

21. A trash container, comprising:
a container body having a receiving cavity therein and a body opening;
an annular container cover comprising a cover housing and a cover base defining an inlet opening and an enclosure chamber, wherein the annular container cover is configured to be mounted on top of the container body to communicate the inlet opening with the body opening of the container body, wherein the annular container cover has a rear inner sidewall, a front inner sidewall and left and right inner sidewalls, wherein the container cover consists of a lid which is configured to be selectively flipped down to close the inlet opening and flipped up inwardly and downwardly to open the inlet opening; and
a lid inward and downward flipping arrangement, received in the enclosure chamber of the container cover, comprising:
a power source and a transmission mechanism, which are installed in the enclosure chamber and arranged at one of a left side and a right side of the annular container cover, and configured to drive the lid to rotate about a flipping axis of the lid to selectively flip up the lid to an open state that the lid is positioned in an upright manner with only an upper portion of the lid extending above the container cover upwardly and a lower portion extending within the inlet opening of the container cover, and flip down the lid to a close state that the lid is positioned flatly to cover the inlet opening, and
a lid pivot device for pivotally connecting the lid to the container cover, wherein the lid pivot device comprises:
a pair of lid support bases,
a pair of support wings respectively and downwardly extended from two side portions of a bottom surface of the lid while two lid supporting edges are defined between the two support wings and the two side edges of the lid respectively, and
a pair of pivot axles integrally protruded on the pair support wings respectively and configured to be rotatably coupled with the pair of lid support bases respectively along the flipping axis, wherein the power source and the transmission mechanism are arranged at one of a left side and a right side of the annular container cover and coupled to one of the pair of pivot axles to drive the lid to rotate about the flipping axis;
wherein the lid inward and downward flipping arrangement is configured to selectively flip up the lid to the open state in which the lid is positioned in the upright manner adjacent to the rear inner sidewall of the annular container cover, a rear end as well as the lower portion of the lid position in the inlet opening and adjacent to the rear inner sidewall of the annular container cover, only the upper portion and a front end of the lid vertically extend above a top surface of the annular container cover, such that the inlet opening is maximized at the top surface of the annular container cover;
wherein the lid inward and downward flipping arrangement is configured to selectively flip down the lid to a close state in which the lid is flatly supported at the same height with the top surface of the annular container cover to cover the inlet opening.

22. The trash container, as recited in claim 21, wherein the pair of lid support bases has a pair of pivot holes respectively, wherein the pair of pivot axles is configured to be rotatably inserted into the pair of pivot holes of the pair of lid support bases respectively to define the flipping axis, wherein the pair of pivot holes is formed at symmetrical rear portions of the pair of lid support bases coaxially and respectively.

23. The trash container, as recited in claim 22, wherein each of the pair of pivot axles is protruded on rear portions of the pair of support wings of the lid respectively, and wherein the pair of pivot holes is shaped and sized for the pair of pivot axles to be rotatably inserted therein respectively such that the lid is able to pivotally flip up to the open state and flip down to the close state about the flipping axis with respect to the annular container cover.

24. The trash container, as recited in claim 21, wherein each of the pair of lid support bases is extended from the front inner sidewall rearwardly towards the rear inner sidewall to define a rear groove between the rear inner sidewall and a rear end of the corresponding lid support base and a top groove between the corresponding lid support base and the top surface of the annular container cover, wherein an upper surface of each of the pair of lid support bases forms a lid support surface for supporting two lid supporting edges of the lid, and wherein the two lid supporting edges are defined between the two support wings and two side edges of the lid respectively.

25. The trash container, as recited in claim 23, wherein a first distance defined between the flipping axis to an upper surface of the lid is smaller than a second distance defined between the flipping axis to the rear inner sidewall of the container cover, and that the second distance is slightly smaller than a third distance defined between the flipping axis and a bottom of the inlet opening.

26. The trash container, as recited in claim 25, wherein a distance between each of the pivot holes to an upper surface of the lid is smaller than a distance between each of the pivot holes to the rear inner sidewall, wherein the distance between each of the pivot holes and the rear inner sidewall is slightly smaller than a distance between each of the pivot holes to a bottom of the inlet opening.

27. The trash container, as recited in claim 21, wherein the power source includes a motor powered by an electric power source to supply a rotation power output, and a transmission mechanism configured to transmit the rotation power output to drive the lid to rotate about the flipping axis via the lid pivot device.

28. The trash container, as recited in claim 26, wherein the power source includes a motor powered by an electric power source to supply a rotation power output, and a transmission mechanism configured to transmit the rotation power output to drive the lid to rotate about the flipping axis via the lid pivot device.

29. The trash container, as recited in claim 21, wherein the lower portion of the lid is a portion of the lid extended from the pivot axle to the rear end of the lid, and positioned and hidden in the inlet opening of the annular container cover in the open state to reduce an overall height of the trash container.

30. The trash container, as recited in claim 29, wherein the lower portion of the lid sinks in the inner ring base of the annular container cover and will not extend beyond a bottom end of the annular container cover during the open state so as to avoid contact with garbage and trash in the receiving cavity of the container body.

31. The trash container, as recited in claim 21, wherein, when the lid is selectively opened, the lower portion of the lid is sunk into a ring inner portion of the annular container cover while the upper portion of the lid upwardly extends out of the top surface of the annular container cover to maximize the inlet opening at the top surface of the annular container cover.

32. The trash container, as recited in claim 28, wherein the motor is electrically connected to one or more batteries to supply a rotation power output to the transmission mechanism, wherein the motor, the one or more batteries, and the transmission mechanism are installed in the enclosure chamber, wherein one of the pair of pivot axles is configured to extend through the corresponding pivot hole to be moveably and detachably coupled to the transmission mechanism, and wherein the one of the pair of pivot axles coupled with the transmission mechanism acts as a driving pivot axle while the other pivot axle acts as a driven pivot axle.

33. The trash container, as recited in claim 21, wherein the lid is integrally provided with a slant step edge downwardly extending along the rear end thereof, wherein, when the lid is in the close state, the slant step edge is downwardly and rearwardly extended to a position slightly lower than an upper surface of the lid and the top surface of the annular container cover, and wherein the slant step edge is positioned below and hidden under the top surface of the annular container cover to cover a gap formed at a junction of the rear end of the lid and the top surface of the annular container cover without blocking flipping up and down motions of the lid.

34. The trash container, as recited in claim 33, wherein the slant step edge has a gradient transition along the slant step edge to allow garbage and trash to fall into the receiving cavity of the trash container due to gravity.

35. The trash container, as recited in claim 24, wherein the lid is integrally provided with a slant step edge downwardly extending along the rear end thereof, wherein, when the lid is in the close state, the slant step edge is downwardly and rearwardly extended to a position slightly lower than an upper surface of the lid and the top surface of the annular container cover, and wherein the slant step edge is positioned below and hidden under the top surface of the annular container cover to cover a gap formed at a junction of the rear end of the lid and the top surface of the annular container cover without blocking flipping up and down motions of the lid, wherein the slant step edge has a gradient transition along the slant step edge to allow garbage and trash to fall into the receiving cavity of the trash container due to gravity.

36. The trash container, as recited in claim 26, wherein the lid is integrally provided with a slant step edge downwardly extending along the rear end thereof, wherein, when the lid is in the close state, the slant step edge is downwardly and rearwardly extended to a position slightly lower than an upper surface of the lid and the top surface of the annular container cover, and wherein the slant step edge is positioned below and hidden under the top surface of the annular container cover to cover a gap formed at a junction of the rear end of the lid and the top surface of the annular container cover without blocking flipping up and down motions of the lid, wherein the slant step edge has a gradient transition along the slant step edge to allow garbage and trash to fall into the receiving cavity of the trash container due to gravity.

37. The trash container, as recited in claim 21, further comprising a trigger-control driving circuit configured to be electrically connected to the transmission mechanism for controlling the lid to selectively open and close via the transmission mechanism, wherein the trigger-control driving circuit comprises a trigger controller for triggering the transmission mechanism to selectively open and close the lid and a level detector for detecting a height of trash contained in the receiving cavity of the container body, wherein the trigger controller comprises at least one sensor selected from a group consisting of a vibration sensor, a reflective infrared sensor, a touch sensor, and other trigger sensors, wherein the reflective infrared sensor generates a driving signal to trigger the transmission mechanism to selectively open and close the lid when an object is detected within a detection zone, wherein the vibration sensor generates a driving signal to trigger the transmission mechanism to selectively open and close the lid when vibration or movement is detected, and wherein the touch sensor generates a driving signal to trigger the transmission mechanism to selectively open and close the lid when physical contact or pressure is detected.

38. The trash container, as recited in claim 37, wherein the level detector is provided to detect a predetermined threshold height of trash contained in the receiving cavity of the trash container, wherein the predetermined threshold height is set lower than a height of the cover housing of the annular container cover from the bottom wall of the trash container to a bottom surface of the cover housing, and wherein a driving signal generated from the trigger controller is provided to the transmission mechanism to selectively open and close the lid when the height of the trash in the receiving cavity, as detected by the level detector, is lower than the predetermined threshold height, and stops triggering the transmission mechanism to selectively open and close the lid when it is detected that the height of the trash in the receiving cavity exceeds the predetermined threshold height.

39. An operation process of selectively opening and closing a single lid of a trash container, comprising steps of:
(a) driving a single lid to flip inwards and downwards about a flipping axis to an open state by a lid inward and downward flipping arrangement, wherein the single lid is positioned in an upright position adjacent to a rear inner sidewall of an annular container cover, wherein a rear end as well as a lower portion of the single lid position in an inlet opening and adjacent to the rear inner sidewall, wherein only an upper portion and a front end of the single lid vertically extend above a top surface of the annular container cover, wherein an inlet opening is maximized at the top surface of the annular container cover, and wherein a front side of the trash container has nothing extending out to leave a clear and total opening space to a user; and
(b) driving the single lid to flip down about the flipping axis to a close state by the lid inward and downward flipping arrangement, wherein the single lid is flatly positioned on the top surface of the annular container cover to close the inlet opening.

40. The operation process, as recited in claim 39, wherein the step (a) and the step (b) are controlled by a control method comprising steps of:
sending an instruction to emit a driving signal when a user is intended to throw trash into the trash container;
generating the driving signal from a trigger controller when the instruction is received from the user; and
determining whether a height of trash in the receiving cavity of the trash container exceeds a predetermined threshold height by a level detector, wherein the driving signal is indirectly transmitted to execute the step (a) when the height of the trash is lower than the predetermined threshold height, and wherein an action signal generated from the level detector is sent to not execute the step (a) when the height of the trash exceeds the predetermined threshold height.
